(19) United States
(12) Patent Application Publication
(10) Pub. No.: US 2026/0238450 A1
(43) Pub. Date: Aug. 13, 2026

(54) UPLINK TRANSMISSION METHOD

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/156,779

(22) PCT Filed: Feb. 17, 2023
(86) PCT No.: PCT/CN2023/076940

§ 371 Date: Aug. 14, 2025

(51) Int. Cl. H04L 5/00; H04L 5/14

(52) U.S. Cl. CPC H04L 5/0094; H04L 5/14

(57) ABSTRACT

The present disclosure relates to an uplink transmission method. The method is performed by a terminal device. The method receiving uplink scheduling information sent by a network device; sending first uplink information on a first radio resource, the uplink scheduling information indicating the first uplink information; and sending second uplink information on a second radio resource. The second uplink information is other uplink information than the first uplink information and the other uplink information is indicated by the uplink scheduling information, and the second radio resource or the first radio resource includes a first time-domain resource, and the first time-domain resource is configured to carry an uplink channel and a downlink channel.

### CROSS-REFERENCE TO RELATED APPLICATIONS

The present application is a U.S. National Stage of International Application No. PCT/CN2023/076940 filed on Feb. 17, 2023, the entire contents of which are incorporated herein by reference for all purposes.

### TECHNICAL FIELD

The present disclosure relates to the field of communication technology, and in particular, to an uplink transmission method and device and a storage medium.

### BACKGROUND

In a wireless communication system, the Frequency Division Duplex (FDD) communication technology may utilize different frequencies for uplink and downlink communications, and the Time Division Duplex (TDD) communication technology may utilize different slots (time slots) for uplink and downlink communications. Unlike the above FDD and TDD communication technologies, the Full Duplex (FD, also known as XDD) communication technology may perform uplink and downlink transmissions simultaneously on the same frequency and slot, thereby improving the utilization of spectrum resources.

### SUMMARY

The present disclosure provides an uplink transmission method and device and a storage medium.

A first aspect of embodiments of the present disclosure provides an uplink transmission method performed by a terminal device, including:
receiving uplink scheduling information sent by a network device;
sending first uplink information on a first radio resource, the uplink scheduling information indicating the first uplink information; and
sending second uplink information on a second radio resource, wherein the second uplink information is other uplink information than the first uplink information and the other uplink information is indicated by the uplink scheduling information, and
the second radio resource or the first radio resource includes a first time-domain resource, and the first time-domain resource is configured to carry an uplink channel and a downlink channel.

A second aspect of embodiments of the present disclosure provides an uplink transmission method performed by a network device, including:
sending uplink scheduling information to a terminal device;
receiving first uplink information on a first radio resource, the uplink scheduling information indicating the first uplink information; and
receiving second uplink information on a second radio resource, wherein the second uplink information is other uplink information than the first uplink information and the other uplink information is indicated by the uplink scheduling information, and
the second radio resource or the first radio resource includes a first time-domain resource, and the first time-domain resource is configured to carry an uplink channel and a downlink channel.

A third aspect of embodiments of the present disclosure provides an uplink transmission device applied to a terminal device, including:
a first receiving module, configured to receive uplink scheduling information sent by a network device; and
a first sending module, configured to send first uplink information on a first radio resource, the uplink scheduling information indicating the first uplink information; and to send second uplink information on a second radio resource, wherein the second uplink information is other uplink information than the first uplink information and the other uplink information is indicated by the uplink scheduling information, and the second radio resource or the first radio resource includes a first time-domain resource, and the first time-domain resource is configured to carry an uplink channel and a downlink channel.

A fourth aspect of embodiments of the present disclosure provides an uplink transmission device applied to a network device, including:
a second sending module, configured to send uplink scheduling information to a terminal device; and
a second receiving module, configured to receive first uplink information on a first radio resource, the uplink scheduling information indicating the first uplink information; and to receive second uplink information on a second radio resource, wherein the second uplink information is other uplink information than the first uplink information and the other uplink information is indicated by the uplink scheduling information, and the second radio resource or the first radio resource includes a first time-domain resource, and the first time-domain resource is configured to carry an uplink channel and a downlink channel.

A fifth aspect of embodiments of the present disclosure provides an uplink transmission device, including:
a processor; and
a memory for storing processor-executable instructions,
wherein the processor is configured to execute steps in the uplink transmission method according to the first aspect of the present disclosure.

A sixth aspect of embodiments of the present disclosure provides an uplink transmission device, including:
a processor; and
a memory for storing processor-executable instructions,
wherein the processor is configured to execute steps in the uplink transmission method according to the second aspect of the present disclosure.

A seventh aspect of embodiments of the present disclosure provides a computer-readable storage medium having computer program instructions thereon that, when executed by a processor, implement steps in the uplink transmission method according to the first aspect of the present disclosure.

An eighth aspect of embodiments of the present disclosure provides a computer-readable storage medium having computer program instructions thereon that, when executed by a processor, implement steps in the uplink transmission method according to the second aspect of the present disclosure.

A ninth aspect of embodiments of the present disclosure provides a communication system, including:
a terminal device, which may perform the uplink transmission method according to the first aspect of the present disclosure; and
a network device, which may perform the uplink transmission method according to the second aspect of the present disclosure.

It should be understood that the above general description and the detailed description that follows are exemplary and explanatory only and do not limit the present disclosure.

### BRIEF DESCRIPTION OF THE DRAWINGS

The accompanying drawings herein are incorporated into and form a part of the specification, illustrate embodiments consistent with the present disclosure, and are used in conjunction with the specification to explain the principle of the present disclosure.

FIG. 1 is a schematic diagram illustrating a communication system according to an embodiment.

FIG. 2 is a schematic diagram illustrating a communication slot (time slot) according to an embodiment.

FIG. 3 is a flowchart illustrating an uplink transmission method according to an embodiment.

FIG. 4 is a flowchart illustrating an uplink transmission method according to an embodiment.

FIG. 5 is a flowchart illustrating an uplink transmission method according to an embodiment.

FIG. 6 is a flowchart illustrating an uplink transmission method according to an embodiment.

FIG. 7 is a flowchart illustrating an uplink transmission method according to an embodiment.

FIG. 8 is a flowchart illustrating an uplink transmission method according to an embodiment.

FIG. 9 is a block diagram illustrating an uplink transmission device according to an embodiment.

FIG. 10 is a block diagram illustrating an uplink transmission device according to an embodiment.

FIG. 11 is a block diagram illustrating an uplink transmission device according to an embodiment.

FIG. 12 is a block diagram illustrating an uplink transmission device according to an embodiment.

FIG. 13 is a block diagram illustrating an uplink transmission device according to an embodiment.

### DETAILED DESCRIPTION

The following description will provide a detailed explanation of the embodiments, examples of which are illustrated in the accompanying drawings. When the following description relates to the figures, the same reference numerals in different figures refer to the same or similar elements unless otherwise indicated. The implementations described in the following embodiments do not represent all implementations consistent with the present disclosure. Rather, they are merely examples of devices and methods consistent with some aspects of the present disclosure as detailed in the appended claims.

It should be noted that all actions of acquiring signals, information, or data in the present disclosure are performed in compliance with the applicable data protection regulations and policies in the local country and with the authorization of the respective device owners.

In the description of the present disclosure, the terms such as “first”, “second”, etc. are used to distinguish similar objects and should not be understood as indicating a specific order or sequence. Further, when the description is made with reference to the figures, the same reference numerals in different figures indicate the same elements unless otherwise indicated.

In the description of the present disclosure, “a plurality of” refers to two or more, and other quantifiers have similar meanings unless otherwise indicated. “At least one”, “one or more” or similar expressions refer to any combination of the following items, including a single item or any combination of a plurality of items. For example, “at least one” may indicate any number. For another example, “one or more” of a, b, and c may indicate: a, b, c, a-b, a-c, b-c, or a-b-c, where a, b, and c may be singular or plural. The term “and/or” is used to describe a relationship between associated objects, indicating that there may be three types of relationships. For example, “A and/or B” may represent A alone, both A and B, or B alone. Here, A and B may be singular or plural. The character “/” indicates that the associated objects before and after the same are in an “or” relationship. The singular forms “a/an”, “said” and “the” are also intended to include plural forms unless the context clearly indicates otherwise.

Although operations or steps are described in a specific order in the embodiments or drawings of the present disclosure, this should not be interpreted as requiring that these operations or steps be performed in the specific order shown or in a serial order, or that all the operations or steps shown must be performed to achieve a desired result. In an embodiment of the present disclosure, if there is not conflict, these operations or steps may be performed in any order or in parallel, only a portion of these operations or steps may be performed, or operations or steps from a plurality of embodiments or figures may be arbitrarily combined, which is not limited in the present disclosure.

Firstly, the implementation environment of the embodiments of the present disclosure will be described below.

The technical solutions of the embodiments of the present disclosure may be applied to various communication systems. Such a communication system may include one or more of the fourth generation (4G) communication systems, the fifth generation (5G) communication systems, and other future wireless communication systems (e.g., 6G). The communication system may also include one or more of a Public Land Mobile Network (PLMN) network, a Device-to-Device (D2D) communication system, a Machine-to-Machine (M2M) communication system, an Internet of Things (IOT) communication system, a Vehicle-to-Everything (V2X) communication system, or other communication systems.

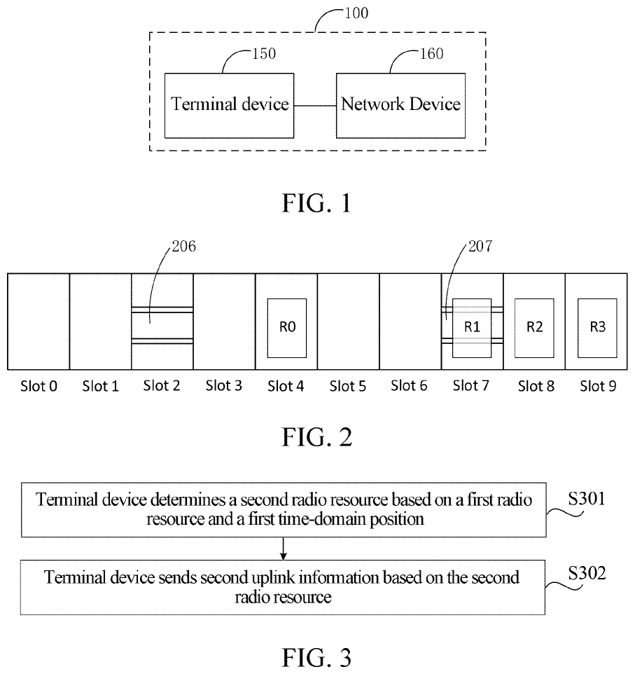

FIG. 1 is a schematic diagram of a communication system 100 according to an embodiment. As shown in FIG. 1, the communication system 100 may include a terminal device 150 and a network device 160. The communication system 100 may be used to support a 4G network access technology, such as Long Term Evolution (LTE) access technology, a 5G network access technology, such as New Radio Access Technology (New RAT), or other future wireless communication technologies. It should be noted that in the communication system, a numbers of network devices and/or terminal devices each may be one or more. The network devices and terminal devices shown in FIG. 1 is merely an illustrative example, which is not limiting.

The network device in FIG. 1 may be used to support the access of the terminal device, for example, the network device may include an evolutional Node B (eNB or eNodeB) in LTE; the network device may also include a next generation Node B (gNB or gNodeB) in 5G network; the network device may also include a NG Radio Access Network (NG-RAN) device in 5G network; and the network device may also include a Broadband Network Gateway (BNG), an aggregation switch, a non-3GPP access device, or a base station in a future evolved Public Land Mobile Network (PLMN), etc. For example, the network device in an embodiment of the present disclosure may include various forms of base stations, such as macro base station, micro base station (also known as small base station), relay station, access point, 5G base station or future base station, satellite, transmitting and receiving point (TRP), transmitting point (TP), mobile switching center, and device that performs a base station function in device-to-device (D2D), machine-to-machine (M2M), Internet of Things (IoT), vehicle-to-everything (V2X), or other communications, which is not specifically limited in the embodiments of the present disclosure. For convenience of description, in all embodiments of the present disclosure, the device that provides wireless communication functionality to the terminal device is collectively referred to as a network device or base station.

The terminal device in FIG. 1 may be an electronic device that provides voice and/or data connectivity, for example, the terminal device may also be referred to as such as user equipment (UE), Subscriber Unit (SU), Mobile Station (MS), Station, Terminal, or the like. For example, the terminal device may include a smartphone, smart wearable device, smart speaker, smart tablet, wireless modem, Wireless Local Loop (WLL) station, Personal Digital Assistant (PDA), Customer Premise Equipment (CPE), etc. With the development of wireless communication technology, devices that can access a communication system, communicate with a network device in the communication system, communicate with other objects through the communication system, or directly communicate with two or more devices may all be terminal devices in the embodiments of the present disclosure. For example, the terminal device may be a terminal and a vehicle in intelligent transportation, a household equipment in smart home, an electricity meter, a voltage monitoring instrument, and an environmental monitoring instrument in smart grid, a video monitoring instrument and a cash register in intelligent security networks, etc. In an embodiment of the present disclosure, the terminal device may communicate with the network device, and a plurality of terminal devices may also communicate with each other. The terminal device may be static and fixed or mobile, which is not limited in the present disclosure.

In some embodiments, the terminal device in the above communication system may include a first terminal device that supports a full-duplex communication technology. For example, the first terminal device may be a terminal device with a protocol release equal to or higher than Release 18. For another example, the first terminal device may support a first terminal capability. The first terminal capability may be used to indicate that the first terminal device supports to configure an uplink band in a downlink time-domain resource or a flexible time-domain resource. Alternatively, the first terminal capability may be used to indicate that the first terminal device identifies or uses an uplink band configured in a downlink time-domain resource or a flexible time-domain resource. The uplink band (UL band) may also be referred to as an uplink sub-band (UL sub-band). Alternatively, the first terminal capability may be used to indicate that the first terminal device supports to configure an uplink radio resource and a downlink radio resource at the same time-domain position.

In some other embodiments, the terminal device in the above communication system may also include a second terminal device that does not support the full-duplex communication technology. For example, the second terminal device may be a terminal device with a protocol release equal to or lower than Release 17. For another example, the first terminal device may not support the above first terminal capability.

It should be noted that the full-duplex communication may support uplink and downlink transmissions in part or all of time-frequency resources, for example, some resource blocks (RB) may be used for both uplink and downlink transmissions, thereby improving spectrum resource utilization.

FIG. 2 is a schematic diagram of a communication slot according to an embodiment. As shown in FIG. 2, there are 10 slots from slot 0 to slot 9, in which slot 0, slot 1, slot 5, and slot 6 are slots used for downlink transmission, and slot 3, slot 4, slot 8, and slot 9 are slots used for uplink transmission. Slot 2 and slot 7 may be used for both uplink and downlink transmissions, meaning that slot 2 and slot 7 are slots that uplink and downlink frequency-domain resources shares. For example, all of the frequency-domain resources in slot 2 may be used for downlink transmission, and the frequency-domain resource 206 in the middle portion of slot 2 may also be used for uplink transmission. In other words, the frequency-domain resource 206 in slot 2 may be used for both uplink and downlink transmissions. Similarly, all of the frequency-domain resources in slot 7 may be used for downlink transmission, and the frequency-domain resource 207 in the middle portion of slot 7 may also be used for uplink transmission. In other words, the frequency-domain resource 207 in slot 7 may be used for both uplink and downlink transmission.

In some embodiments, the terminal device may send uplink information based on uplink scheduling information. For example, the terminal device may send the uplink information according to the indication in the uplink scheduling information received from a network device. The uplink scheduling information may be downlink control information (DCI) used for uplink scheduling, and the uplink information may be uplink data and/or uplink signaling transmitted over an uplink channel, which may be a physical uplink shared channel (PUSCH).

In an implementation, the uplink scheduling information may be used to indicate the terminal device to send at least one uplink information, a first one of the uplink information sent by the terminal device based on the uplink scheduling information may be referred to as first uplink information, and second and subsequent ones of the uplink information sent by the terminal device based on the uplink scheduling information may be referred to as second uplink information. As shown in FIG. 2, the terminal device may send the first uplink information through a first radio resource R0 based on the uplink scheduling information sent by the network device, and send the second uplink information through second radio resources R1, R2, and R3. The second uplink information carried by R1, R2, and R3 may be the same or different.

In an implementation, the uplink scheduling information may be used to indicate a time-domain resource and/or a frequency-domain resource to be used by the terminal device for sending the uplink information.

As shown in FIG. 2, a time-domain position of the first radio resource R0 is slot 4, and the time-domain positions of the second radio resources R1, R2, and R3 may be in slot 7, slot 8, and slot 9, respectively. Slot 4, slot 8, and slot 9 may all be slots used for uplink transmission, and slot 7 may be used for both uplink and downlink transmissions. In some scenarios, the number of frequency-domain resources corresponding to R0 is greater than the number of frequency-domain resources 207 available for uplink transmission in slot 7, resulting in the second uplink information R1 failing to be transmitted due to insufficient resources. Here, the number of frequency-domain resources may refer to the number of subcarriers.

To solve the above problem, the present disclosure provides an uplink transmission method, in which a terminal device may determine a second radio resource based on a first radio resource and a first time-domain position, and send second uplink information based on the second radio resource. The first time-domain position may be a time-domain position shared by uplink and downlink frequency-domain resources, such as slot 2 and/or slot 7 shown in FIG. 2.

FIG. 3 is a flowchart illustrating an uplink transmission method according to an embodiment. The method may be performed by the terminal device in the communication system described above. As shown in FIG. 3, the method may include the following steps.

In S301, the terminal device determines a second radio resource based on a first radio resource and a first time-domain position.

In some embodiments, the first time-domain position may be a time-domain position shared by an uplink frequency-domain resource and a downlink frequency-domain resource, such as slot 2 and/or slot 7 shown in FIG. 2.

There may be one or more first time-domain positions. For example, the first time-domain position may include at least one slot, or at least one subframe, or at least one symbol.

It can be understood that with the development of technology, the first time-domain position may include at least one resource unit, and the resource unit is a resource on a physical layer that can be scheduled.

In the following implementations or embodiments, the first time-domain position may also be referred to as a first time-domain resource.

In some embodiments, the first radio resource may be a radio resource used for transmitting first uplink information, and the second radio resource may be a radio resource used for transmitting second uplink information.

The first uplink information and the second uplink information each may be uplink data and/or uplink signaling transmitted over an uplink channel, and the uplink channel may be a Physical Uplink Shared Channel (PUSCH). The first uplink information and the second uplink information may be the same or different.

In some embodiments, the first uplink information is a first one of uplink information sent based on uplink scheduling information, and the second uplink information is other uplink information than the first uplink information and sent based on the uplink scheduling information.

In some embodiments, the first uplink information may be an uplink initial transmission, and the second uplink information may be an uplink repetition corresponding to the uplink initial transmission. The uplink repetition may include a retransmission based on Hybrid Automatic Repeat Request (HARQ) or an active repetition.

In some embodiments, the second uplink information is an uplink repetition corresponding to the first uplink information.

In some other embodiments, the first uplink information may be a first one of uplink information based on Listen Before Talk (LBT) scheduling, and the second uplink information may be other uplink information based on the LBT scheduling.

It should be noted that the above radio resource may include Resource Element (RE), Resource Element Group (REG), Resource Block (RB), or Resource Block Group (RBG). For example, the first radio resource may include at least one first RB, and the second radio resource may include at least one second RB.

In some embodiments, the first radio resource may be R0 as shown in FIG. 2, and the second radio resource may include at least one of R1, R2, and R3 as shown in FIG. 2.

In some embodiments, the terminal device may be a terminal that supports to configure an uplink radio resource and a downlink radio resource at the same time-domain position. For example, the terminal device may support a first terminal capability. The first terminal capability may be used to indicate that the terminal device supports to configure the uplink radio resource and the downlink radio resource at the same time-domain position. Alternatively, the first terminal capability may be used to indicate that the first terminal device supports to configure an uplink band in a downlink time-domain resource or a flexible time-domain resource. Alternatively, the first terminal capability may be used to indicate that the first terminal device identifies or uses an uplink band configured in a downlink time-domain resource or a flexible time-domain resource. The uplink band (UL band) may also be referred to as an uplink sub-band (UL sub-band).

In some embodiments, the terminal device may first determine whether the time-domain position of the radio resource available to the terminal device includes the first time-domain position. If the time-domain position of the radio resource available to the terminal device includes the first time-domain position, the terminal device determines the second radio resource based on the first radio resource and the first time-domain position.

In some other embodiments, the terminal device may first determine whether the terminal device itself supports to configure the uplink radio resource and the downlink radio resource at the same time-domain position. If the terminal device supports to configure the uplink radio resource and the downlink radio resource at the same time-domain position, the terminal device determines the second radio resource based on the first radio resource and the first time-domain position.

In some other embodiments, the terminal device may first determine whether the terminal device itself supports to configure the uplink radio resource and the downlink radio resource at the same time-domain position, and whether the time-domain position of the radio resource available to the terminal device includes the first time-domain position. If the terminal device supports to configure the uplink radio resource and the downlink radio resource at the same time-domain position, and the time-domain position of the radio resource available to the terminal device includes the first time-domain position, the terminal device determines the second radio resource based on the first radio resource and the first time-domain position.

In this way, the terminal device may determine whether to perform the step of determining the second radio resource based on the first radio resource and the first time-domain position according to the terminal capability information thereof and/or the information of the available radio resource, thereby improving the processing efficiency of the terminal device.

In some embodiments, the second radio resource may not include a fourth radio resource. A time-domain position of the fourth radio resource is the first time-domain position.

For example, when determining the second radio resource, the terminal device may skip the radio resource corresponding to the first time-domain position and select a radio resource available for uplink transmission in other time-domain positions than the first time-domain position as the second radio resource.

For another example, the terminal device may determine a first time-domain length based on the uplink scheduling information received and determine the second radio resource based on the first time-domain length.

In an implementation, the second radio resource may not include the above fourth radio resource, a time-domain length of the second radio resource is equal to the first time-domain length, and the first time-domain length is a time-domain length of the radio resource required for sending the second uplink information and determined based on the uplink scheduling information. In this way, the fourth radio resource may be skipped to select sufficient radio resources to transmit the second uplink information.

In another implementation, the second radio resource may not include the above fourth radio resource, and the time-domain length of the second radio resource is less than the first time-domain length, for example, the sum of the time-domain lengths of the second radio resource and the fourth radio resource is equal to the first time-domain length.

In some other embodiments, the second radio resource may include the above fourth radio resource.

For example, when determining the second radio resource, the terminal device may also select the radio resource corresponding to the first time-domain position.

Thus, the terminal device may use any of the above manners to determine the second radio resource.

In S302, the terminal device sends the second uplink information based on the second radio resource.

In some embodiments, the terminal device may send the second uplink information on the second radio resource. Correspondingly, the network device may also receive the second uplink information on the second radio resource.

In some other embodiments, when the number of frequency-domain resources in the second radio resource is greater than or equal to the number of frequency-domain resources in the first radio resource, the terminal device may use the second radio resource to send the second uplink information. Correspondingly, the network device may use the second radio resource to receive the second uplink information.

In some other embodiments, when the number of frequency-domain resources in the second radio resource is less than the number of frequency-domain resources in the first radio resource, the terminal device may discard the second uplink information corresponding to the second radio resource. Similarly, the network device may also discard the second uplink information corresponding to the second radio resource, for example, by not receiving the second uplink information via the second radio resource. The second radio resource may be used for transmitting other data or transmitting data from other terminal devices.

In an embodiment of the present application, the user equipment discards the radio resource, which may mean that the user equipment is not expected to send data on the radio resource or the network device does not expect the user equipment to send data on the radio resource. Similarly, the user equipment discards information 1, which may mean that the user equipment is not expected to send the data, or the network device does not expect the user equipment to send the data.

In some other embodiments, when the number of frequency-domain resources in the second radio resource is less than the number of frequency-domain resources in the first radio resource, the terminal device may increase a transport code rate of the second uplink information and send the second uplink information via the second radio resource based on the new transport code rate. Similarly, the network device may also receive the second uplink information via the second radio resource based on the new transport code rate.

The transport code rate is used to measure the amount of information carried by the symbol or analogue signal after the information is encoded and modulated. Alternatively, the transport code rate is used to measure the number of symbols after the same information is encoded and modulated, or the size of the time-domain and/or frequency-domain occupied by the analogue signal after the same information is encoded and modulated.

It should be noted that in some embodiments of the present disclosure, the above step S301 may be an optional step.

With the above method, a terminal device may determine a second radio resource based on a first radio resource and a first time-domain position, and send second uplink information based on the second radio resource. Here, the first time-domain position is a time-domain position shared by an uplink frequency-domain resource and a downlink frequency-domain resource, the first radio resource is a radio resource used to transmit first uplink information, the second radio resource is a radio resource used to transmit the second uplink information, the first uplink information is a first one of uplink information sent based on uplink scheduling information, and the second uplink information is other uplink information than the first uplink information and sent based on the uplink scheduling information. In this way, a transmission failure may be avoided for uplink repetition in a full-duplex scenario, thereby improving transmission reliability.

In some embodiments of the present disclosure, the terminal device performs uplink transmission through the following steps: the terminal device receives uplink scheduling information sent by a network device, sends first uplink information on a first radio resource, and sends second uplink information on a second radio resource. The uplink scheduling information may indicate the first uplink information, and the second uplink information may be other uplink information than the first uplink information and indicated by the uplink scheduling information.

In some embodiments, the second radio resource may include a first time-domain resource, and the first time-domain resource may be used to carry both an uplink channel and a downlink channel.

In some other embodiments, the first radio resource may also include the first time-domain resource, and the first time-domain may also be used to carry both the uplink channel and the downlink channel.

It should also be noted that the above first time-domain resource may also be referred to as a first time-domain position, for example, the first time-domain resource may be a resource corresponding to the first time-domain position in the above embodiments of the present disclosure.

The first time-domain resource includes any one of:
a time-domain position shared by an uplink frequency-domain resource and a downlink frequency-domain resource;
a time-domain position shared by the uplink frequency-domain resource and the downlink frequency-domain resource and having a number of available uplink frequency-domain resources less than a number of first frequency-domain resources, wherein the number of first frequency-domain resources is a number of frequency-domain resources in the first radio resource; or
a time-domain position shared by the uplink frequency-domain resource and the downlink frequency-domain resource and configured as a first type, wherein the first type is a type determined based on a type identifier sent from the network device to the terminal device.

In some embodiments, the above second radio resource may include the first time-domain resource, and the above first radio resource does not include the first time-domain resource. The terminal device may determine a second transport code rate based on a number of first frequency-domain resources, a number of second frequency-domain resources and a first transport code rate, and send the second uplink information on the second radio resource at the second transport code rate.

The first transport code rate is a transport code rate of the first uplink information, the number of first frequency-domain resources is a number of frequency-domain resources in the first radio resource, and the number of second frequency-domain resources is a number of frequency-domain resources in the second radio resource.

In some embodiments, the above second radio resource may include the first time-domain resource, and the above first radio resource does not include the first time-domain resource. The terminal device may determine a second transport code rate based on a number of resources in the first radio resource, a number of resources in the second radio resource, and a first transport code rate, and send the second uplink information on the second radio resource at the second transport code rate.

The first transport code rate is a transport code rate of the first uplink information, the number of resources in the first radio resource is a number of time-frequency resources in the first radio resource, and the number of second frequency-domain resources is a number of frequency-domain resources in the second radio resource.

In some embodiments, the second transport code rate may be greater than the first transport code rate, and the number of frequency-domain resources in the second radio resource may be less than the number of frequency-domain resources in the first radio resource.

In some other embodiments, the second transport code rate may be equal to the first transport code rate, and the terminal device may send third uplink information via the second radio resource. The third uplink information is a subset of the second uplink information. Alternatively, the third uplink information may be referred to as a portion of the second uplink information.

For example, the third uplink information may be information obtained by performing first processing on the second uplink information, a number of frequency-domain resources corresponding to the third uplink information is less than a number of frequency-domain resources corresponding to the second uplink information, and a number of time-domain resources corresponding to the third uplink information may be the same as a number of time-domain resources corresponding to the second uplink information In some embodiments, the above first processing may be punching processing.

For example, the number of frequency-domain resources corresponding to the first radio resource is N, the number of frequency-domain resources corresponding to the second radio resource is M, and N is greater than M. The third uplink information may be obtained by deleting (N-M) frequency-domain resources from the second uplink information. The number of frequency-domain resources corresponding to the third uplink information is M.

In an implementation, the third uplink information may be obtained by deleting the (N-M) frequency-domain resources starting from the lowest frequency in the second frequency-domain resources.

In an implementation, the third uplink information may be obtained by deleting the (N-M) frequency-domain resources starting from the highest frequency in the second frequency-domain resources.

In this way, the terminal device may send the second uplink information based on the second radio resource.

In some embodiments of the present disclosure, the terminal device may determine the third radio resource, and the third radio resource is not used for sending the second uplink information.

In some embodiments, the third radio resource may include the above first time-domain resource.

In some embodiments, the above second radio resource does not include the third radio resource.

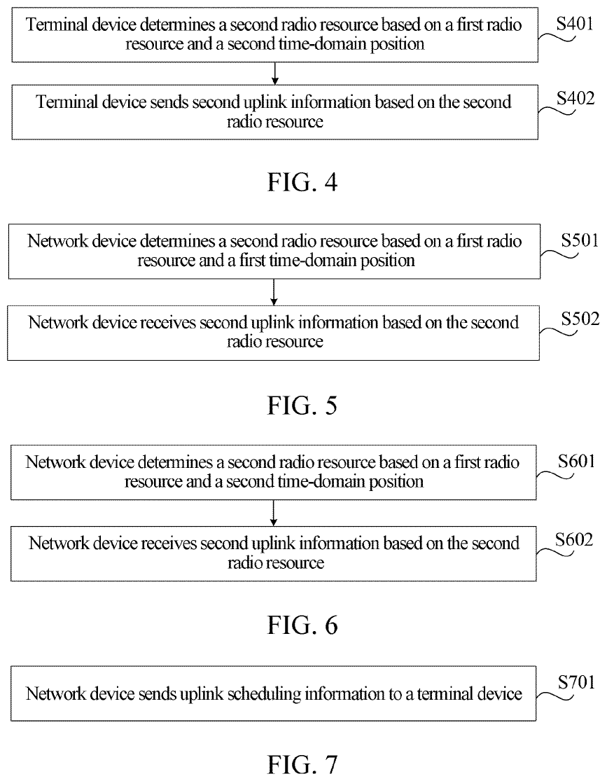

FIG. 4 is a flowchart illustrating an uplink transmission method according to an embodiment. As shown in FIG. 4, the method may include the following steps.

In S401, the terminal device determines a second radio resource based on a first radio resource and a second time-domain position.

In some embodiments, the second time-domain position may be the above first time-domain position. For example, the second time-domain position may be a time-domain position shared by an uplink frequency-domain resource and a downlink frequency-domain resource, such as slot 2 and/or slot 7 shown in FIG. 2.

In some other embodiments, the second time-domain position may include a time-domain position in the above first time-domain position with the number of available uplink frequency-domain resources less than the number of first frequency-domain resources. Here, the number of first frequency-domain resources refers to the number of first frequency-domain resources corresponding to the first radio resource. The first radio resource is a radio resource for sending the first uplink information.

For example, if the first radio resource for sending the first uplink information is 10 RBs, and the number of available uplink frequency-domain resources in the first time-domain position is 6 RBs, the second time-domain position may include the first time-domain position.

In some other embodiments, the second time-domain position may include a time-domain position configured as a first type in the first time-domain position. Here, the first type is determined based on a type identifier sent from the network device to the terminal device.

The type identifier may be used to indicate whether the type corresponding to the first time-domain position is a first type. The terminal device may receive the type identifier sent by the network device via a first message, and the first message may include at least one of a Radio Resource Control (RRC) message, a Medium Access Control Control Element (MAC CE), Downlink Control Information (DCI), or other messages sent by the network device to the terminal device.

In S402, the terminal device sends second uplink information based on the second radio resource.

It should be noted that when there are no contradictions, this embodiment may be combined with the above embodiments or implementations of the present disclosure and various optional solutions thereof. The specific implementations of the above steps in this embodiment may also refer to the descriptions in the above embodiments of the present disclosure, which will not be repeated here.

With the above method, the terminal device may determine the second radio resource based on the first radio resource and the second time-domain position, and send the second uplink information based on the second radio resource.

In some embodiments, the second radio resource may not include a fourth radio resource. A time-domain position of the fourth radio resource is the second time-domain position.

For example, when determining the second radio resource, the terminal device may skip the radio resource corresponding to the second time-domain position and select a radio resource available for uplink transmission in other time-domain positions than the second time-domain position as the second radio resource.

For another example, the terminal device may determine a first time-domain length based on the uplink scheduling information received and determine the second radio resource based on the first time-domain length.

In an implementation, the second radio resource may not include the above fourth radio resource, a time-domain length of the second radio resource is equal to the first time-domain length, and the first time-domain length is a time-domain length of the radio resource required for sending the second uplink information and determined based on the uplink scheduling information. In this way, the fourth radio resource may be skipped to select sufficient radio resources to transmit the second uplink information.

In another implementation, the second radio resource may not include the above fourth radio resource, and the time-domain length of the second radio resource is less than the first time-domain length, for example, the sum of the time-domain lengths of the second radio resource and the fourth radio resource is equal to the first time-domain length.

In this way, the second radio resource determined by the terminal device does not include the radio resource which time-domain position is the second time-domain position, and the terminal device may directly send the second uplink information via the second radio resource. Similarly, the network device may also receive the second uplink information via the second radio resource.

In some other embodiments, the second radio resource may include the above fourth radio resource, and similarly, the time-domain position of the fourth radio resource may be the second time-domain position.

In this way, the terminal device may send the second uplink information based on the second radio resource and the fourth radio resource. The example thereof is as follows.

In some embodiments, the terminal device may determine a second transport code rate of the second uplink information based on a number of second frequency-domain resources in the fourth radio resource, a number of first frequency-domain resources, and a first transport code rate of the second uplink information; and send the second uplink information via the fourth radio resource based on the second transport code rate. Similarly, the network device may also receive the second uplink information via the fourth radio resource based on the second transport code rate.

The number of second frequency-domain resources may be the number of available fourth radio resources at the second time-domain position, for example, the number of available RBs. The number of frequency-domain resources occupied by the second uplink information after being encoded based on the second transport code rate may be less than or equal to the number of second frequency-domain resources.

For example, a ratio of the number of second frequency-domain resources to the number of first frequency-domain resources may first be obtained, and the second transport code rate may be calculated based on this ratio and the first transport code rate.

In an implementation, when the number of second frequency-domain resources is less than the number of first frequency-domain resources, the second transport code rate may be greater than the first transport code rate.

In this way, the transport code rate may be increased, and thus the second uplink information may be sent using fewer frequency-domain resources; therefore, the second uplink information may be successfully sent via the second frequency-domain resources, which avoids sending failure due to insufficient resources.

In another implementation, when the number of second frequency-domain resources is greater than the number of first frequency-domain resources, the second transport code rate may be less than or equal to the first transport code rate.

In this way, the transport code rate may be reduced based on the number of frequency-domain resources, and more frequency-domain resources may be used to send the second uplink information, which may improve the reliability of sending the second uplink information.

In some other embodiments, the terminal device may adjust a frequency hopping parameter corresponding to the second uplink information based on the number of second frequency-domain resources in the fourth radio resource and the number of first frequency-domain resources, and send the second uplink information via the fourth radio resource based on the frequency hopping parameter. Similarly, the network device may also receive the second uplink information via the fourth radio resource based on the frequency hopping parameter.

For example, when the number of second frequency-domain resources is greater than the number of first frequency-domain resources, a new frequency hopping parameter may be determined based on the number of second frequency-domain resources (wide bandwidth), and the second uplink information may be sent via the fourth radio resource based on the frequency hopping parameter. It should be noted that different bandwidths may correspond to different frequency hopping parameters, and the specific correspondence thereof may refer to corresponding descriptions in the relevant protocol, which is not repeated here.

Similarly, when the number of second-domain resources is less than the number of first-domain resources, a new frequency hopping parameter may also be determined based on the number of second-domain resources (narrow bandwidth).

In this way, the frequency hopping parameter may be adjusted based on the number of frequency-domain resources, which may improve the reliability of sending the second uplink information.

In some other embodiments, the terminal device may adjust the number of frequency-domain resources in the fourth radio resource used for sending the second uplink information based on a scaling factor according to the number of second frequency-domain resources in the fourth radio resource and the number of first frequency-domain resources, and send the second uplink information via the adjusted fourth radio resource. Similarly, the network device may also adjust the number of frequency-domain resources in the fourth radio resource used for receiving the second uplink information based on the scaling factor and receive the second uplink information via the adjusted fourth radio resource.

The scaling factor may be any pre-set value or may be a value determined based on a ratio or difference between the number of second frequency-domain resources and the number of first frequency-domain resources.

For example, when the number of second frequency-domain resources is greater than the number of first frequency-domain resources, the number of frequency-domain resources in the fourth radio resource may be increased based on the scaling factor, and the second uplink information may be sent via the adjusted fourth radio resource.

In this way, more frequency-domain resources may be used to send the second uplink information, which may improve the reliability of sending the second uplink information.

In some other embodiments, the terminal device may send the second uplink information using other radio resources than the fourth radio resource in the second radio resource, or the terminal device may discard the second uplink information on the fourth radio resource.

For example, when the number of second frequency-domain resources in the fourth radio resource is less than the number of first frequency-domain resources, the terminal device may send the second uplink information using other radio resources than the fourth radio resource in the second radio resource.

For another example, when the number of second frequency-domain resources in the fourth radio resource is less than the number of first frequency-domain resources, the terminal device may discard the second uplink information on the fourth radio resource. For example, the terminal device may not send the second uplink information on the fourth radio resource.

For yet another example, when the number of second frequency-domain resources in the fourth radio resource is greater than or equal to the number of first frequency-domain resources, the terminal device may send the second uplink information via the second radio resource.

It should be noted that when the number of second frequency-domain resources is less than the number of first frequency-domain resources, continuously sending the second uplink information via the fourth radio resource would result in a failure in sending the second uplink information. Therefore, this embodiment may avoid a transmission failure of the second uplink information, which improves transmission reliability.

In some other embodiments, when the number of second frequency-domain resources in the fourth radio resource is less than the number of first frequency-domain resources, the terminal device may perform a first processing on the uplink channel based on the number of second frequency-domain resources and the number of first frequency-domain resources to send the second uplink information.

In some embodiments, the first processing may be a punching processing, which may include:
encoding the second uplink information to third frequency-domain resources, wherein the number of resources in the third frequency-domain resources is equal to the number of first frequency-domain resources; mapping frequency-domain resources, which number is the same as the number of second frequency-domain resources, in the third frequency-domain resources to the fourth radio resource, and discarding the frequency-domain resources which number is the same as the number of third frequency-domain resources; and sending the encoded second uplink information via the fourth radio resource.

The number of third frequency-domain resources may be the difference between the number of first frequency-domain resources and the number of second frequency-domain resources.

For example, the number of first frequency-domain resources is N and the number of second frequency-domain resources is M, then the number of discarded third frequency-domain resources is (N-M). The M frequency-domain resources starting from the highest frequency in the third frequency-domain resources may be mapped to the fourth radio resource, or the M frequency-domain resources starting from the lowest frequency in the third frequency-domain resources may be mapped to the fourth radio resource, or any M frequency-domain resources consecutive in frequency in the third frequency-domain resources may be selected and mapped to the fourth radio resource, or any M frequency-domain resources non-consecutive in frequency in the third frequency-domain resources may be selected and mapped to the fourth radio resource.

In this way, with the above first processing, the second uplink information may be successfully sent via the fourth radio resource.

It should be noted that in the above embodiment, the network device may also determine the second radio resource in the same manner and receive the second uplink information via the second radio resource, which will not be repeated here.

In this way, the terminal device may use any of the above manners to send the second uplink information, which may improve the reliability of uplink transmission.

FIG. 5 is a flowchart illustrating an uplink transmission method according to an embodiment. The method may be performed by the network device in the communication system described above. As shown in FIG. 5, the method may include the following steps.

In S501, the network device determines a second radio resource based on a first radio resource and a first time-domain position.

In some embodiments, the first time-domain position may be a time-domain position shared by an uplink frequency-domain resource and a downlink frequency-domain resource, such as slot 2 and/or slot 7 shown in FIG. 2.

There may be one or more first time-domain positions. For example, the first time-domain position may include at least one slot, or at least one subframe, or at least one symbol.

It should be noted that the first time-domain position may also be referred to as a first time-domain resource.

In some embodiments, the first radio resource may be a radio resource used for transmitting first uplink information, and the second radio resource may be a radio resource used for transmitting second uplink information.

The first uplink information and the second uplink information each may be uplink data and/or uplink signaling transmitted over an uplink channel, and the uplink channel may be a Physical Uplink Shared Channel (PUSCH). The first uplink information and the second uplink information may be the same or different.

In some embodiments, the first uplink information is a first one of uplink information sent by the terminal device based on uplink scheduling information, and the second uplink information is other uplink information than the first uplink information and sent by the terminal device based on the uplink scheduling information.

In some embodiments, the first uplink information may be an uplink initial transmission, and the second uplink information may be an uplink repetition corresponding to the uplink initial transmission. The uplink repetition may include a retransmission based on Hybrid Automatic Repeat Request (HARQ) or an active repetition.

In some embodiments, the second uplink information is an uplink repetition corresponding to the first uplink information.

In some other embodiments, the first uplink information may be a first one of uplink information based on Listen Before Talk (LBT) scheduling, and the second uplink information may be other uplink information based on the LBT scheduling.

It should be noted that the above radio resource may include Resource Element (RE), Resource Element Group (REG), Resource Block (RB), or Resource Block Group (RBG). For example, the first radio resource may include at least one first RB, and the second radio resource may include at least one second RB.

In some embodiments, the first radio resource may be R0 as shown in FIG. 2, and the second radio resource may include at least one of R1, R2, and R3 as shown in FIG. 2.

In some embodiments, the terminal device may be a terminal that supports to configure an uplink radio resource and a downlink radio resource at the same time-domain position. For example, the terminal device may support the above first terminal capability.

In some embodiments, the network device may first determine whether the time-domain position of the radio resource available to the terminal device includes the first time-domain position. If the time-domain position of the radio resource available to the terminal device includes the first time-domain position, the network device determines the second radio resource based on the first radio resource and the first time-domain position.

In some other embodiments, the network device may first determine whether the terminal device supports to configure the uplink radio resource and the downlink radio resource at the same time-domain position. If the terminal device supports to configure the uplink radio resource and the downlink radio resource at the same time-domain position, the network device determines the second radio resource based on the first radio resource and the first time-domain position.

In some other embodiments, the network device may first determine whether the terminal device supports to configure the uplink radio resource and the downlink radio resource at the same time-domain position, and whether the time-domain position of the radio resource available to the terminal device includes the first time-domain position. If the terminal device supports to configure the uplink radio resource and the downlink radio resource at the same time-domain position, and the time-domain position of the radio resource available to the terminal device includes the first time-domain position, the network device determines the second radio resource based on the first radio resource and the first time-domain position.

In this way, the network device may determine whether to perform the step of determining the second radio resource based on the first radio resource and the first time-domain position according to the capability information of the terminal device and/or the information of the available radio resource, thereby improving the processing efficiency.

In some embodiments, the second radio resource may not include a fourth radio resource. A time-domain position of the fourth radio resource is the first time-domain position.

For example, when determining the second radio resource, the network may skip the radio resource corresponding to the first time-domain position and select a radio resource available for uplink transmission in other time-domain positions than the first time-domain position as the second radio resource.

In some other embodiments, the second radio resource may include the above fourth radio resource.

For example, when determining the second radio resource, the terminal device may also select the radio resource corresponding to the first time-domain position.

In S502, the network device receives the second uplink information based on the second radio resource.

In some embodiments, the network device may receive the second uplink information on the second radio resource.

In some other embodiments, when the number of frequency-domain resources in the second radio resource is greater than or equal to the number of frequency-domain resources in the first radio resource, the network device may use the second radio resource to receive the second uplink information.

In some other embodiments, when the number of frequency-domain resources in the second radio resource is less than the number of frequency-domain resources in the first radio resource, the network device may discard the second uplink information corresponding to the second radio resource, for example, by not receiving the second uplink information via the second radio resource. The second radio resource may be used for transmitting other data or transmitting data from other terminal devices.

In some other embodiments, when the number of frequency-domain resources in the second radio resource is less than the number of frequency-domain resources in the first radio resource, the network device may increase a transport code rate of the second uplink information and receive the second uplink information via the second radio resource based on the new transport code rate.

It should be noted that in some embodiments of the present disclosure, the above step S501 may be an optional step.

With the above method, a network device may determine a second radio resource based on a first radio resource and a first time-domain position, and receive second uplink information based on the second radio resource. Here, the first time-domain position is a time-domain position shared by an uplink frequency-domain resource and a downlink frequency-domain resource, the first radio resource is a radio resource used to transmit first uplink information, the second radio resource is a radio resource used to transmit the second uplink information, the first uplink information is a first one of uplink information sent by a terminal device based on uplink scheduling information, and the second uplink information is other uplink information than the first uplink information and sent by the terminal device based on the uplink scheduling information. In this way, a transmission failure may be avoided for uplink repetition in a full-duplex scenario, thereby improving transmission reliability.

In some embodiments of the present disclosure, the network device may receive uplink information through the following steps: the network device sends uplink scheduling information to a terminal device, receives first uplink information on a first radio resource, and receives second uplink information on a second radio resource. The uplink scheduling information indicates the first uplink information, and the second uplink information is other uplink information than the first uplink information and indicated by the uplink scheduling information.

In some embodiments, the second radio resource may include a first time-domain resource, and the first time-domain resource may be used to carry both an uplink channel and a downlink channel.

In some other embodiments, the first radio resource may also include the first time-domain resource, and the first time-domain may be also used to carry both the uplink channel and the downlink channel.

With the above method, a transmission failure may be avoided for uplink repetition in a full-duplex scenario, thereby improving transmission reliability.

It should be noted that the above first time-domain resource may also be referred to as a first time-domain position, for example, the first time-domain resource may be a resource corresponding to the first time-domain position in the above embodiments of the present disclosure.

The first time-domain resource includes any one of:
a time-domain position shared by an uplink frequency-domain resource and a downlink frequency-domain resource;
a time-domain position shared by the uplink frequency-domain resource and the downlink frequency-domain resource and having a number of available uplink frequency-domain resources less than a number of first frequency-domain resources, wherein the number of first frequency-domain resources is a number of frequency-domain resources in the first radio resource; or
a time-domain position shared by the uplink frequency-domain resource and the downlink frequency-domain resource and configured as a first type, wherein the first type is a type determined based on a type identifier sent from the network device to the terminal device.

In some embodiments, the above second radio resource may include the first time-domain resource, and the above first radio resource does not include the first time-domain resource. The network device may determine a second transport code rate based on a number of first frequency-domain resources, a number of second frequency-domain resources and a first transport code rate, and receive the second uplink information on the second radio resource at the second transport code rate.

The first transport code rate is a transport code rate of the first uplink information, the number of first frequency-domain resources is a number of frequency-domain resources in the first radio resource, and the number of second frequency-domain resources is a number of frequency-domain resources in the second radio resource.

In some embodiments, the second transport code rate may be greater than the first transport code rate, and the number of frequency-domain resources in the second radio resource may be less than the number of frequency-domain resources in the first radio resource.

In some other embodiments, the second transport code rate may be equal to the first transport code rate, and the network device may receive third uplink information on the second radio resource. The third uplink information is a subset of the second uplink information.

For example, the third uplink information may be information obtained by performing a first processing on the second uplink information, a number of frequency-domain resources corresponding to the third uplink information is less than a number of frequency-domain resources corresponding to the second uplink information, and a number of time-domain resources corresponding to the third uplink information may be the same as a number of time-domain resources corresponding to the second uplink information

In some embodiments, the above first processing may be punching processing.

For example, the number of frequency-domain resources corresponding to the first radio resource is N, the number of frequency-domain resources corresponding to the second radio resource is M, and N is greater than M. The third uplink information may be obtained by deleting (N-M) frequency-domain resources from the second uplink information. The number of frequency-domain resources corresponding to the third uplink information is M.

In an implementation, the third uplink information may be obtained by deleting the (N-M) frequency-domain resources starting from the lowest frequency in the second frequency-domain resources.

In an implementation, the third uplink information may be obtained by deleting the (N-M) frequency-domain resources starting from the highest frequency in the second frequency-domain resources.

In this way, the terminal device may send the second uplink information based on the second radio resource.

In some embodiments of the present disclosure, the terminal device may determine the third radio resource, and the third radio resource is not used for sending the second uplink information.

In some embodiments, the third radio resource may include the above first time-domain resource.

In some embodiments, the above second radio resource does not include the third radio resource.

FIG. 6 is a flowchart illustrating an uplink transmission method according to an embodiment. As shown in FIG. 6, the method may include the following steps.

In S601, the network device determines a second radio resource based on a first radio resource and a second time-domain position.

In some embodiments, the second time-domain position may be the above first time-domain position. For example, the second time-domain position may be a time-domain position shared by an uplink frequency-domain resource and a downlink frequency-domain resource, such as slot 2 and/or slot 7 shown in FIG. 2.

In some other embodiments, the second time-domain position may include a time-domain position in the above first time-domain position with the number of available uplink frequency-domain resources less than the number of first frequency-domain resources. Here, the number of first frequency-domain resources refers to the number of first frequency-domain resources corresponding to the first radio resource. The first radio resource is a radio resource for sending the first uplink information.

For example, if the first radio resource for sending the first uplink information is 10 RBs, and the number of available uplink frequency-domain resources in the first time-domain position is 6 RBs, the second time-domain position may include the first time-domain position.

In some other embodiments, the second time-domain position may include a time-domain position configured as a first type in the above first time-domain position. Here, the first type is determined based on a type identifier sent from the network device to the terminal device.

The type identifier may be used to indicate whether the type corresponding to the first time-domain position is the first type.

In some implementations, the network device may send the type identifier to the terminal device, and the type identifier may be used to indicate the terminal device to determine the first type corresponding to the first time-domain position.

For example, the network device may send the type identifier to the terminal device via a first message, and the first message may include at least one of RRC message, MAC CE, DCI, or other messages sent by the network device to the terminal device.

In S602, the network device receives second uplink information based on the second radio resource.

It should be noted that when there are no contradictions, this embodiment may be combined with the above embodiments or implementations of the present disclosure and various optional solutions thereof. The specific implementations of the above steps in this embodiment may also refer to the descriptions in the above embodiments of the present disclosure, which will not be repeated here.

With the above method, the network device may determine the second radio resource based on the first radio resource and the second time-domain position, and receive the second uplink information based on the second radio resource.

In some embodiments, the second radio resource may not include a fourth radio resource. A time-domain position of the fourth radio resource is the second time-domain position.

For example, when determining the second radio resource, the network device may skip the radio resource corresponding to the second time-domain position and select a radio resource available for uplink transmission in other time-domain positions than the second time-domain position as the second radio resource.

For another example, the network device may determine a first time-domain length for transmitting the second uplink information and determine the second radio resource based on the first time-domain length.

In an implementation, the second radio resource may not include the above fourth radio resource, a time-domain length of the second radio resource is equal to the first time-domain length, and the first time-domain length is a time-domain length of the radio resource required for sending the second uplink information and determined based on the uplink scheduling information. In this way, the fourth radio resource may be skipped to select sufficient radio resources to transmit the second uplink information.

In another implementation, the second radio resource may not include the above fourth radio resource, and the time-domain length of the second radio resource is less than the first time-domain length, for example, the sum of the time-domain lengths of the second radio resource and the fourth radio resource is equal to the first time-domain length.

In this way, the second radio resource determined by the network device does not include the radio resource which time-domain position is the second time-domain position, and the network device may directly receive the second uplink information via the second radio resource.

In some other embodiments, the second radio resource may include the above fourth radio resource, and similarly, the time-domain position of the fourth radio resource may be the second time-domain position.

In this way, the network device may receive the second uplink information based on the second radio resource and the fourth radio resource. The example thereof is as follows.

In some embodiments, the network device may determine a second transport code rate of the second uplink information based on a number of second frequency-domain resources in the fourth radio resource, a number of first frequency-domain resources, and a first transport code rate of the second uplink information; and receive the second uplink information via the fourth radio resource based on the second transport code rate.

The number of second frequency-domain resources may be the number of available fourth radio resources at the second time-domain position, for example, the number of available RBs. The number of frequency-domain resources occupied by the second uplink information after being encoded based on the second transport code rate may be less than or equal to the number of second frequency-domain resources.

For example, a ratio of the number of second frequency-domain resources to the number of first frequency-domain resources may first be obtained, and the second transport code rate may be calculated based on this ratio and the first transport code rate.

In an implementation, when the number of second frequency-domain resources is less than the number of first frequency-domain resources, the second transport code rate may be greater than the first transport code rate.

In this way, the transport code rate may be increased, and thus the second uplink information may be transmitted using fewer frequency-domain resources; therefore, the second uplink information may be successfully received via the second frequency-domain resources, which avoids transmission failure of the second uplink information due to insufficient resources.

In another implementation, when the number of second frequency-domain resources is greater than the number of first frequency-domain resources, the second transport code rate may be less than or equal to the first transport code rate.

In this way, the transport code rate may be reduced based on the number of frequency-domain resources, and more frequency-domain resources may be used to transmit the second uplink information, which may improve the reliability of transmitting the second uplink information.

In some other embodiments, the network device may receive the second uplink information using other radio resources than the fourth radio resource in the second radio resource.

For example, when the number of second frequency-domain resources in the fourth radio resource is less than the number of first frequency-domain resources, the network device may receive the second uplink information using other radio resources than the fourth radio resource in the second radio resource.

For another example, when the number of second frequency-domain resources in the fourth radio resource is greater than or equal to the number of first frequency-domain resources, the network device may receive the second uplink information via the second radio resource.

It should be noted that when the number of second frequency-domain resources is less than the number of first frequency-domain resources, continuously transmitting the second uplink information via the fourth radio resource would result in a transmission failure of the second uplink information. Therefore, this embodiment actively reduces the transmission of invalid second uplink information, thereby improving transmission reliability.

In some other embodiments, when the number of second frequency-domain resources in the fourth radio resource is less than the number of first frequency-domain resources, the network device may receive the second uplink information processed by a first processing via the fourth radio resource.

In some embodiments, the first processing may be a punching processing.

It should be noted that the specific implementation of the punching processing may refer to the description of the terminal device side in the above embodiments of the present disclosure, which will not be repeated here.

In this way, the network device may receive the second uplink information using any of the above methods, thereby improving the reliability of uplink transmission.

FIG. 7 is a flowchart illustrating an uplink transmission method according to an embodiment. As shown in FIG. 7, the method may include S701.

In S701, the network device sends uplink scheduling information to a terminal device.

The uplink scheduling information is used to indicate the terminal device to: send first uplink information via a first radio resource, determine a second radio resource based on the first radio resource and a first time-domain position, and send second uplink information based on the second radio resource. The first time-domain position may be a time-domain position shared by an uplink frequency-domain resource and a downlink frequency-domain resource. The first uplink information is a first one of uplink information sent by the terminal device based on the uplink scheduling information, and the second uplink information is other uplink information than the first uplink information and sent by the terminal device based on the uplink scheduling information.

It should be noted that when there are no contradictions, this embodiment may be combined with the above embodiments or implementations of the present disclosure and various optional solutions thereof. The specific implementations of the above steps in this embodiment may also refer to the descriptions in the above embodiments of the present disclosure, which will not be repeated here.

In this way, the network device may send the uplink scheduling information and receive the second uplink information using any of the aforementioned methods, thereby improving the reliability of uplink transmission.

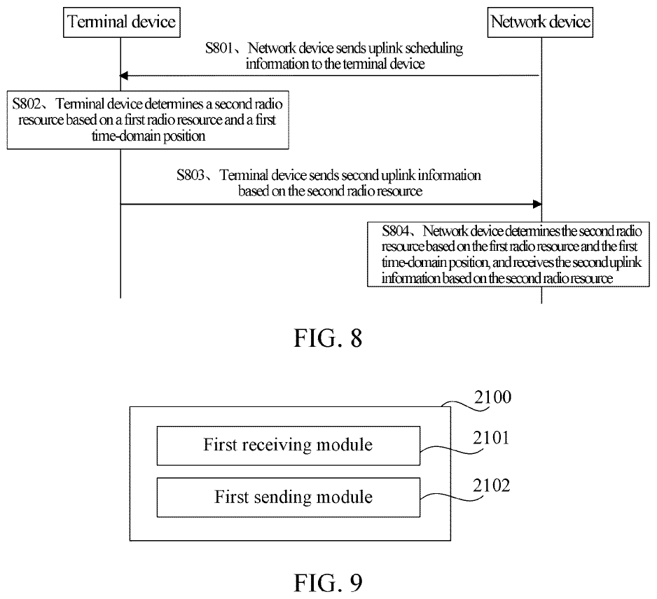

FIG. 8 is a flowchart illustrating an uplink transmission method according to an embodiment. As shown in FIG. 8, the method may include:
S801, a network device sends uplink scheduling information to a terminal device;
S802, the terminal device determines a second radio resource based on a first radio resource and a first time-domain position;
S803, the terminal device sends second uplink information based on the second radio resource; and
S804, the network device determines the second radio resource based on the first radio resource and the first time-domain position, and receives the second uplink information based on the second radio resource.

It should be noted that when there are no contradictions, this embodiment may be combined with the above embodiments or implementations of the present disclosure and various optional solutions thereof. The specific implementations of the above steps in this embodiment may also refer to the descriptions in the above embodiments of the present disclosure, which will not be repeated here.

In this way, the terminal device may determine the second radio resource and send the second uplink information based on the second radio resource, and the network device may also determine the second radio resource in the same manner and receive the second uplink information based on the second radio resource, thereby improving the reliability of uplink transmission.

In some embodiments of the present disclosure, the network device may send uplink scheduling information (which uplink scheduling information may be downlink control signaling DCI used for uplink scheduling), and the uplink scheduling information may be used to schedule the terminal to send uplink information. The uplink information may also be referred to as uplink service, for example, the uplink information may include uplink data and/or uplink signaling.

The terminal device may monitor the uplink scheduling information and send the uplink information based on the uplink scheduling information.

When the terminal device supports Release 18 full-duplex communication (e.g., XDD) capabilities, or when the terminal device is configured by the network device with an uplink band (or UL sub-band) in a downlink slot, the second uplink information, which may be a PUSCH repetition or a plurality of PUSCHs scheduled by a single time-domain (e.g., a plurality of uplink services scheduled by the same DCI), may be transmitted using any of the following manners.
In manner 1, when the terminal device is scheduled for PUSCH repetition, or is scheduled for a plurality of PUSCHs in a single DCI time-domain, a slot identified by a first identifier may not be used for PUSCH transmission, and the first identifier may be configured by the network device and transmitted to the terminal device via DCI, MAC CE, RRC, or other messages.
In manner 2, when the terminal device is scheduled for PUSCH repetition, or is scheduled for a plurality of PUSCHs in a single DCI time-domain, a slot corresponding to DL PRB may not be used for PUSCH transmission.
In manner 3, when the terminal device is scheduled for PUSCH repetition, or is scheduled for a plurality of PUSCHs in a single DCI time-domain, and a PRB resource included in the UL band where the retransmitted PUSCH is located is less than a frequency-domain resource configured for an initial PUSCH transmission, it may perform rate matching on the PUSCH transmission with a small bandwidth, i.e., increasing the transport code rate to compress the frequency-domain resource.
In manner 4, when the terminal device is scheduled for PUSCH repetition, or is scheduled for a plurality of PUSCHs in a single DCI time-domain, and a PRB resource included in the UL band where the retransmitted PUSCH is located is less than a frequency-domain resource configured for an initial PUSCH transmission, the PUSCH transmission on a slot identified by a first identifier may be discarded, and this first identifier may be configured by the network device and transmitted to the terminal device via DCI, MAC CE, RRC, or other messages.
In manner 5, when the terminal device is scheduled for PUSCH repetition, or is scheduled for a plurality of PUSCHs in a single DCI time-domain, and a PRB resource included in the UL band where the retransmitted PUSCH is located is less than a frequency-domain resource configured for an initial PUSCH transmission, the PUSCH transmission on a slot corresponding to DL PRB is discarded.
In manner 6, when the terminal device is scheduled for PUSCH repetition, or is scheduled for a plurality of PUSCHs in a single DCI time-domain, and a PRB resource included in the UL band where the retransmitted PUSCH is located is less than a frequency-domain resource configured for an initial PUSCH transmission, a punching processing is performed on the PUSCH, and the principle of such processing is that the initial PUSCH transmission occupies N frequency-domain resources, while the number of the frequency-domain resources with a small bandwidth is M, then the M RBs starting from the high/low frequency of PUSCH are mapped onto the small bandwidth, and (N-M) RBs are discarded.
In manner 7, when the terminal device is scheduled for PUSCH repetition, or is scheduled for a plurality of PUSCHs in a single DCI time-domain, the slot in which a PRB resource included in the UL band is less than a frequency-domain resource configured for an initial PUSCH transmission is skipped.
In manner 8, a scaling factor A is preset, and when the terminal device is scheduled for PUSCH repetition, or is scheduled for a plurality of PUSCHs in a single DCI time-domain, and a PRB resource included in the UL band where the retransmitted PUSCH is located is larger than a frequency-domain resource configured for an initial PUSCH transmission, the frequency-domain resource may be scaled according to the scaling factor A.
In manner 9, when the terminal device is scheduled for PUSCH repetition, or is scheduled for a plurality of PUSCHs in a single DCI time-domain, and a PRB resource included in the UL band where the retransmitted PUSCH is located is larger than a frequency-domain resource configured for an initial PUSCH transmission, the frequency hopping parameter may be re-determined based on a large bandwidth.

In this way, the terminal device may send the second uplink information using any of the above manners, and the network device may receive the second uplink information using the same manner, thereby improving the reliability of uplink transmission.

An embodiment of the present disclosure further provides a communication system, which may include a terminal device and a network device. The terminal device may perform the uplink transmission method involving the terminal device in the above embodiments of the present disclosure, and the network device may perform the uplink transmission method involving the network device in the above embodiments.

FIG. 9 is a block diagram of an uplink transmission device 2100 according to an embodiment. The device may be applied to a terminal device. As shown in FIG. 9, the device 2100 may include:
a first receiving module 2101, configured to receive uplink scheduling information sent by a network device; and
a first sending module 2102, configured to: send first uplink information on a first radio resource, the uplink scheduling information indicating the first uplink information; and send second uplink information on a second radio resource, wherein the second uplink information is other uplink information than the first uplink information and the other uplink information is indicated by the uplink scheduling information, and the second radio resource or the first radio resource includes a first time-domain resource, and the first time-domain resource is configured to carry an uplink channel and a downlink channel.

In some embodiments, the second radio resource include the first time-domain resource, and the first radio resource does not include the first time-domain resource; and the first sending module 2102 is configured to: determine a second transport code rate based on a number of first frequency-domain resources, a number of second frequency-domain resources and a first transport code rate, wherein the first transport code rate is a transport code rate of the first uplink information, the number of first frequency-domain resources is a number of frequency-domain resources in the first radio resource, and the number of second frequency-domain resources is a number of frequency-domain resources in the second radio resource; and send the second uplink information on the second radio resource at the second transport code rate.

In some embodiments, the second transport code rate is greater than the first transport code rate.

In some embodiments, the second transport code rate is equal to the first transport code rate, and the first sending module 2102 is configured to send third uplink information on the second radio resource at the second transport code rate, the third uplink information being a subset of the second uplink information.

In some embodiments, the third uplink information is information obtained by performing first processing on the second uplink information, a number of frequency-domain resources corresponding to the third uplink information is less than a number of frequency-domain resources corresponding to the second uplink information, and a number of time-domain resources corresponding to the third uplink information is the same as a number of time-domain resources corresponding to the second uplink information.

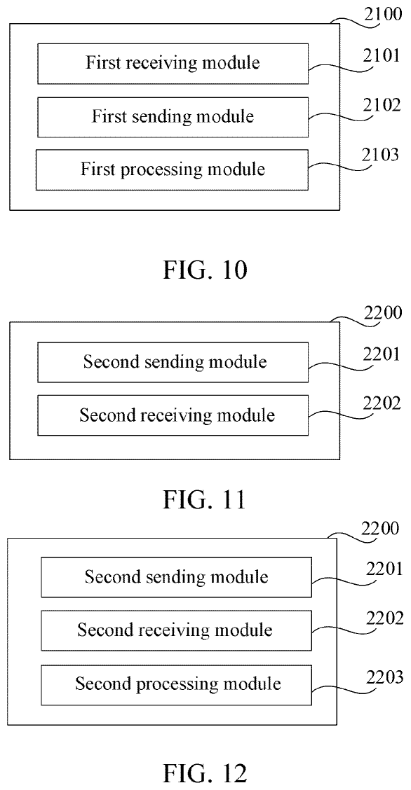

FIG. 10 is a block diagram of an uplink transmission device 2100 according to an embodiment. As shown in FIG. 10, the device 2100 may further include:
a first processing module 2103, configured to determine a third radio resource, wherein the third radio resource is configured to not send the second uplink information.

In some embodiments, the third radio resource includes the first time-domain resource.

In some embodiments, the first time-domain resource includes any one of:
a time-domain position shared by an uplink frequency-domain resource and a downlink frequency-domain resource;
a time-domain position shared by the uplink frequency-domain resource and the downlink frequency-domain resource and having a number of available uplink frequency-domain resources less than a number of first frequency-domain resources, wherein the number of first frequency-domain resources is a number of frequency-domain resources in the first radio resource; or
a time-domain position shared by the uplink frequency-domain resource and the downlink frequency-domain resource and configured as a first type, wherein the first type is a type determined based on a type identifier sent from the network device to the terminal device.

In some embodiments:
a time-domain position of a radio resource available to the terminal device includes the first time-domain resource; or
the terminal device supports to configure an uplink radio resource and a downlink radio resource at a same time-domain position.

In some embodiments, the second uplink information is an uplink repetition corresponding to the first uplink information.

In some embodiments, the first uplink information is a first one of uplink information based on listen before talk (LBT) scheduling, and the second uplink information is other uplink information based on the LBT scheduling.

FIG. 11 is a block diagram of an uplink transmission device 2200 according to an embodiment. The device may be applied to a network device. As shown in FIG. 11, the device 2200 may include:
a second sending module 2201, configured to sending uplink scheduling information to a terminal device; and
a second receiving module 2202, configured to: receive first uplink information on a first radio resource, the uplink scheduling information indicating the first uplink information; and receive second uplink information on a second radio resource, wherein the second uplink information is other uplink information than the first uplink information and the other uplink information is indicated by the uplink scheduling information, and the second radio resource or the first radio resource includes a first time-domain resource, and the first time-domain resource is configured to carry an uplink channel and a downlink channel.

In some embodiments, the second radio resource includes the first time-domain resource, and the first radio resource does not include the first time-domain resource, and the second receiving module 2202 is configured to: determine a second transport code rate based on a number of first frequency-domain resources, a number of second frequency-domain resources and a first transport code rate, wherein the first transport code rate is a transport code rate of the first uplink information, the number of first frequency-domain resources is a number of frequency-domain resources in the first radio resource, and the number of second frequency-domain resources is a number of frequency-domain resources in the second radio resource; and receive the second uplink information on the second radio resource at the second transport code rate.

In some embodiments, the second transport code rate is greater than the first transport code rate.

In some embodiments, the second transport code rate is equal to the first transport code rate, and the second receiving module 2202 is configured to receive third uplink information on the second radio resource at the second transport code rate, the third uplink information being a subset of the second uplink information.

In some embodiments, the third uplink information is information obtained by performing first processing on the second uplink information, a number of frequency-domain resources corresponding to the third uplink information is less than a number of frequency-domain resources corresponding to the second uplink information, and a number of time-domain resources corresponding to the third uplink information is the same as a number of time-domain resources corresponding to the second uplink information.

FIG. 12 is a block diagram of an uplink transmission device 2200 according to an embodiment. As shown in FIG. 12, the device 2200 may further include:
a second processing module 2203, configured to determine a third radio resource, wherein the third radio resource is configured to not receive the second uplink information.

In some embodiments, the third radio resource includes the first time-domain resource.

In some embodiments, the first time-domain resource includes any one of:
a time-domain position shared by an uplink frequency-domain resource and a downlink frequency-domain resource;
a time-domain position shared by the uplink frequency-domain resource and the downlink frequency-domain resource and having a number of available uplink frequency-domain resources less than a number of first frequency-domain resources, wherein the number of first frequency-domain resources is a number of frequency-domain resources in the first radio resource; or
a time-domain position shared by the uplink frequency-domain resource and the downlink frequency-domain resource and configured as a first type, wherein the first type is a type determined based on a type identifier sent from the network device to the terminal device.

In some embodiments, the second sending module 2201 is further configured to send the type identifier to the terminal device, the type identifier being configured to indicate the terminal device to determine the first type corresponding to the first time-domain resource.

In some embodiments, the second uplink information is an uplink repetition corresponding to the first uplink information.

In some embodiments, the first uplink information is a first one of uplink information based on listen before talk (LBT) scheduling, and the second uplink information is other uplink information based on the LBT scheduling.

Regarding the device in the above embodiments, the specific manner in which each module performs operations has been described in details in the embodiments related to the method, and thus will not be repeated here.

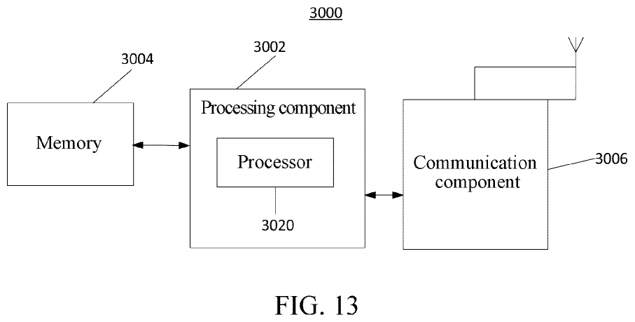

FIG. 13 is a block diagram of an uplink transmission device according to an embodiment. The uplink transmission device 3000 may be the terminal device or the network device in the communication system shown in FIG. 1.

Referring to FIG. 13, the device 3000 may include one or more of a processing component 3002, a memory 3004, and a communication component 3006.

The processing component 3002 may be used to control the overall operations of the device 3000, such as operations associated with display, telephone calls, data communications, camera operations, and recording operations. The processing component 3002 may include one or more processors 3020 to execute instructions to complete all or part of the steps of the above uplink transmission method. In addition, the processing component 3002 may include one or more modules to facilitate interaction between the processing component 3002 and other components. For example, the processing component 3002 may include a multimedia module to facilitate the interaction between the multimedia component and the processing component 3002.

The memory 3004 is configured to store various types of data to support the operation of the device 3000. Examples of these data include instructions for any application or method operating on the device 3000, contact data, phone book data, messages, pictures, videos and the like. The memory 3004 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The communication component 3006 is configured to facilitate wired or wireless communication between the device 3000 and other devices. The device 3000 can access a wireless network based on a communication standard, such as Wi-Fi, 2G, 3G, 4G, 5G, 6G, NB-IoT, eMTC, etc., or combinations thereof. In an embodiment, the communication component 3006 receives a broadcast signal or broadcast related information from an external broadcast management system via a broadcast channel. In an embodiment, the communication component 3006 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the device 3000 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned uplink transmission method.

The above device 3000 may be an independent electronic device or a part of an independent electronic device. For example, in an embodiment, the electronic device may be an integrated circuit (IC) or chip, and the integrated circuit may be a single IC or a collection of a plurality of ICs. The chip may include, but is not limited to, GPU (Graphics Processing Unit), CPU (Central Processing Unit), FPGA (Field Programmable Gate Array), DSP (Digital Signal Processor), ASIC (Application Specific Integrated Circuit), SOC (System on Chip, SoC, or System-on-Chip), etc. The above integrated circuit or chip may be used to execute executable instructions (or codes) to implement the above uplink transmission method. The executable instructions may be stored in the integrated circuit or chip, or obtained from other devices or apparatus. For example, the integrated circuit or chip may include a processor, memory, and an interface for communicating with other devices. The executable instructions may be stored in the processor, and when the executable instructions are executed by the processor, the above uplink transmission method is implemented. Alternatively, the integrated circuit or chip may receive the executable instructions through the interface and transmit the same to the processor for execution, thereby implementing the above uplink transmission method.

In an embodiment, the present disclosure further provides a computer-readable storage medium storing computer program instructions that, when being executed by the processor, implement the steps of the uplink transmission method provided by the present disclosure. For example, the computer-readable storage medium may be a non-transitory computer-readable storage medium including instructions, such as the memory 3004 including instructions, and the instructions may be executed by the processor 3020 of the device 3000 to complete the foregoing uplink transmission method. For example, the non-transitory computer-readable storage medium may be ROM, random access memory (RAM), CD-ROM, magnetic tape, floppy disk, optical data storage device and the like.

Another embodiment also provides a computer program product including a computer program that can be executed by a programmable device, and the computer program includes code segments for executing the above uplink transmission method when being executed by the programmable device.

A person skilled in the art may easily conceive of other embodiments of the present disclosure upon consideration of the specification and practice of the present disclosure. The present disclosure is intended to cover any variations, uses, or adaptations of the present disclosure that follow the general principles of the present disclosure and include the common general knowledge or conventional technical means in the technical field not disclosed by the present disclosure. The specification and embodiments are to be regarded as exemplary only, and the true scope and spirit of the present disclosure are indicated by the following claims.

It is to be understood that the present disclosure is not limited to the precise structures described above and illustrated in the accompanying drawings, and that various modifications and changes may be made without departing from the scope thereof. The scope of the present disclosure is limited only by the appended claims.

1. An uplink transmission method performed by a terminal device, comprising:
receiving uplink scheduling information sent by a network device;
sending first uplink information on a first radio resource, the uplink scheduling information indicating the first uplink information; and
sending second uplink information on a second radio resource,
wherein the second uplink information is other uplink information than the first uplink information and the other uplink information is indicated by the uplink scheduling information, and
the second radio resource or the first radio resource comprises a first time-domain resource, and the first time-domain resource is configured to carry an uplink channel and a downlink channel.

2. The method according to claim 1, wherein the second radio resource comprises the first time-domain resource, and the first radio resource does not comprise the first time-domain resource,
sending the second uplink information on the second radio resource comprises:
determining a second transport code rate based on a number of first frequency-domain resources, a number of second frequency-domain resources and a first transport code rate, wherein the first transport code rate is a transport code rate of the first uplink information, the number of first frequency-domain resources is a number of frequency-domain resources in the first radio resource, and the number of second frequency-domain resources is a number of frequency-domain resources in the second radio resource; and
sending the second uplink information on the second radio resource at the second transport code rate,
wherein the second transport code rate is greater than or equal to the first transport code rate.

3. (canceled)

4. The method according to claim 2, wherein the second transport code rate is equal to the first transport code rate, and sending the second uplink information on the second radio resource at the second transport code rate comprises:
sending third uplink information on the second radio resource at the second transport code rate, the third uplink information being a subset of the second uplink information.

5. The method according to claim 4, wherein the third uplink information is information obtained by performing first processing on the second uplink information, a number of frequency-domain resources corresponding to the third uplink information is less than a number of frequency-domain resources corresponding to the second uplink information, and a number of time-domain resources corresponding to the third uplink information is the same as a number of time-domain resources corresponding to the second uplink information.

6. The method according to claim 1, further comprising:
determining a third radio resource, wherein the third radio resource is configured to not send the second uplink information.

7. The method according to claim 6, wherein the third radio resource comprises the first time-domain resource.

8. The method according to claim 1, wherein the first time-domain resource comprises any one of:
a time-domain position shared by an uplink frequency-domain resource and a downlink frequency-domain resource;
a time-domain position shared by the uplink frequency-domain resource and the downlink frequency-domain resource and having a number of available uplink frequency-domain resources less than a number of first frequency-domain resources, wherein the number of first frequency-domain resources is a number of frequency-domain resources in the first radio resource; or
a time-domain position shared by the uplink frequency-domain resource and the downlink frequency-domain resource and configured as a first type, wherein the first type is a type determined based on a type identifier sent from the network device to the terminal device.

9. The method according to claim 1, wherein,
a time-domain position of a radio resource available to the terminal device comprises the first time-domain resource; or
the terminal device supports to configure an uplink radio resource and a downlink radio resource at a same time-domain position.

10. The method according to claim 1, wherein the second uplink information is an uplink repetition corresponding to the first uplink information.

11. The method according to claim 1, wherein the first uplink information is a first one of uplink information based on listen before talk (LBT) scheduling, and the second uplink information is other uplink information based on the LBT scheduling.

12. An uplink transmission method performed by a network device, comprising:
sending uplink scheduling information to a terminal device;
receiving first uplink information on a first radio resource, the uplink scheduling information indicating the first uplink information; and
receiving second uplink information on a second radio resource,
wherein the second uplink information is other uplink information than the first uplink information and the other uplink information is indicated by the uplink scheduling information, and
the second radio resource or the first radio resource comprises a first time-domain resource, and the first time-domain resource is configured to carry an uplink channel and a downlink channel.

13. The method according to claim 12, wherein the second radio resource comprises the first time-domain resource, and the first radio resource does not comprise the first time-domain resource,
receiving the second uplink information on the second radio resource comprises:
determining a second transport code rate based on a number of first frequency-domain resources, a number of second frequency-domain resources and a first transport code rate, wherein the first transport code rate is a transport code rate of the first uplink information, the number of first frequency-domain resources is a number of frequency-domain resources in the first radio resource, and the number of second frequency-domain resources is a number of frequency-domain resources in the second radio resource; and
receiving the second uplink information on the second radio resource at the second transport code rate,
wherein the second transport code rate is greater than or equal to the first transport code rate.

14. (canceled)

15. The method according to claim 13, wherein the second transport code rate is equal to the first transport code rate, and receiving the second uplink information on the second radio resource at the second transport code rate comprises:
receiving third uplink information on the second radio resource at the second transport code rate, the third uplink information being a subset of the second uplink information,
wherein the third uplink information is information obtained by performing first processing on the second uplink information, a number of frequency-domain resources corresponding to the third uplink information is less than a number of frequency-domain resources corresponding to the second uplink information, and a number of time-domain resources corresponding to the third uplink information is the same as a number of time-domain resources corresponding to the second uplink information.

16. (canceled)

17. The method according to claim 12, further comprising:
determining a third radio resource, wherein the third radio resource is configured to not receive the second uplink information.

18. The method according to claim 17, wherein the third radio resource comprises the first time-domain resource.

19. The method according to claim 12, wherein the first time-domain resource comprises any one of:
a time-domain position shared by an uplink frequency-domain resource and a downlink frequency-domain resource;
a time-domain position shared by the uplink frequency-domain resource and the downlink frequency-domain resource and having a number of available uplink frequency-domain resources less than a number of first frequency-domain resources, wherein the number of first frequency-domain resources is a number of frequency-domain resources in the first radio resource; or
a time-domain position shared by the uplink frequency-domain resource and the downlink frequency-domain resource and configured as a first type, wherein the first type is a type determined based on a type identifier sent from the network device to the terminal device.

20. The method according to claim 19, further comprising:
sending the type identifier to the terminal device, the type identifier being configured to indicate the terminal device to determine the first type corresponding to the first time-domain resource.

21. The method according to claim 12, wherein the second uplink information is an uplink repetition corresponding to the first uplink information.

22-27. (canceled)

28. A terminal device, comprising a processor and a memory having processor-executable instructions stored thereon that, when being executed by the processor, cause the terminal device to implement actions comprising:
receiving uplink scheduling information sent by a network device;
sending first uplink information on a first radio resource, the uplink scheduling information indicating the first uplink information; and
sending second uplink information on a second radio resource,
wherein the second uplink information is other uplink information than the first uplink information and the other uplink information is indicated by the uplink scheduling information, and
the second radio resource or the first radio resource comprises a first time-domain resource, and the first time-domain resource is configured to carry an uplink channel and a downlink channel.

29. A network device, comprising:
a processor; and
a memory having processor-executable instructions stored thereon that, when being executed by the processor, cause the network device to implement the method according to claim 12.
